(19) United States
(12) Patent Application Publication
(10) Pub. No.: US 2014/0169895 A1
(43) Pub. Date: Jun. 19, 2014

(54) PRECISION BORE MACHINE AND METHOD OF PRODUCING A PRECISE BORE

(71) Applicant: Indubrand AG, Baar (CH)

(72) Inventor: Achim Luebbering, Herzebrock-Clarholz (DE)

(73) Assignee: Indubrand AG, Baar (CH)

(21) Appl. No.: 14/020,145

(22) Filed: Sep. 6, 2013

(30) Foreign Application Priority Data
Sep. 7, 2012 (DE) 10 2012 108 378.9

(51) Int. Cl. B23B 41/16

(52) U.S. Cl. CPC B23B 41/16
USPC 408/17

(57) ABSTRACT

A bore machine for producing a very precise bore, as well as a method of producing a very precise bore in a workpiece. The bore machine has a main drive that drives the spindle rotationally as well as travel along the axial direction and an auxiliary drive that provides an oscillating motion in the axial direction that is overlayed over the forward travel motion of the spindle. The auxiliary drive has a first element with a wave-shaped surface and that is movable relative to a second element. During relative motion between the first and second elements, one element is forced to follow the peaks and valleys of the wave-shaped surface, thereby generating the oscillating motion. The auxiliary drive is driven such, that the relative motion between the two elements is at most 30% of the rotational speed of the spindle.

### BACKGROUND INFORMATION

1. Field of the Invention

The invention relates to a precision bore machine.

2. Discussion of the Prior Art

In practice, very close precision is required in many cases when machining a bore, such as, for example, the close tolerances frequently required on the diameter and the roundness of a bore. In this context, it is known to move the borer back and forth slightly in the axial direction during the forward travel of the borer.

DE 10 2007 053 350 A1 discloses a process for machining workpieces. With a programmable bore machine, the forward travel is provided with an adjustable, computer-controlled oscillating motion. This bore machine has two drives, that are controllable independently of each other and of which one of them serves to rotate the spindle. The second drive is used to move the tool forward and is so driven, that this forward motion also has an oscillating component to it. Overlaying or mechanically superposing the oscillating motion onto the forward travel motion is described as a disadvantage.

Mechanically superpositioning oscillating motion over forward travel motion is known in the field. The continual forward travel of the bore tool, which, within the context of the present suggestion, is achieved by the so-called main drive, has an axially oscillating motion overlayed onto it, which is generated by the so-called auxiliary drive. Regardless of whether the elements of the auxiliary drive are provided directly on the spindle or not, that is, are perhaps also a part of the main drive, those elements shall be designated herein as an auxiliary drive that generates the oscillating motion of the spindle. Mechanically overlaying the oscillating motion makes it possible to operate the particular bore machine without electrical power supply, but rather, for example, with pneumatic power, something that is not possible when using a computer-control system to adjust the oscillating motion of the forward travel.

DE 20 2005 008 630 U1 discloses a bore device in which the oscillating motion is mechanically overlayed on the forward travel. In this case, a pendle disc is placed diagonally to the spindle axis. The pendle disc is constructed as a ring that encircles the spindle and has a ring-shaped guide groove that carries a ball that is guided around the spindle. The diagonal position of the pendle disc changes continuously because of the circular travel of the ball and the resulting pitching motion is converted to a oscillating motion running back and forth in the direction of the bore.

DE 102 02 747 A1 discloses a bore machine in which the production of a precise bore in metal material is not the primary focus, but rather, the use of a diamond bore crown or dry bore crown. The bore is made in a material that generates bore dust, such as is common with hammer bore machines. The bore action is accomplished exclusively through the rotation of the bore tool. The bore dust increases the friction of the bore crown and can lead to an undesirable increase in the temperature on the tool. Here, too, the oscillating motion is mechanically superposed. In this machine, a cam lifter is associated with the spindle, in order to remove the bore dust from the bore by means of a gentle axial motion of the bore tool. The cam lifter has a cam disc that rotates with the working spindle, as well as a ring body fixedly attached to the housing, so that the full spindle rotational speed determines the number of the lifts. The wave shaped cam contour of the mentioned cam lifter is supposed to achieve harmonic axial movement, and the temperature increase of the bore tool, particularly of a diamond bore crown, is supposed to be held to a minimum.

When creating a precision bore, it is important that, during the forward travel, the oscillating motion along the forward travel axis break the bore chips that are formed, so that they can be easily transported out of the work piece through the grooves that extend around the circumference of the bore tool. This reduces the danger, that a chip formed at the edge of the produced bore, when the bore tool moves forward, rubs against the edge of the bore hole and damages it or possibly changes the geometry of the bore, particularly its diameter. For example, in the aircraft industry, where greatest precision is required for the position and geometry of the individual bores, for safety reasons, a conventional process is used to create the bores and to break the chips that are created during the bore process and to remove them from the bore.

The oscillation drive of the spindle can in some cases be subject to excessive wear, when, for example, a wavy collar or annulus extends together with the spindle and its corresponding high rotational speed, the wave profile of which contacts an opposing piece that is fixedly attached to the housing, that is, does not rotate with the collar. These two surfaces that run against each other with a relatively high rotational speed wear quickly and have a negative economic impact on the service life of the bore machine.

### BRIEF SUMMARY OF THE INVENTION

It is an object of the invention to provide a bore machine, that has a long service life, and to provide a process, with which the greatest possible number of high precision bores are produced with the least possible complications.

The invention is a bore machine in which there is no so-called “absolute” difference in rotational speed between the two elements of the auxiliary drive, in which one element, for example, is driven with the full rotational speed and the other is not driven at all. Rather, these two elements of the bore machine according to the invention are driven with a relative motion between the elements. This relative motion of the two elements, which can also be called a so-called “relative” rotational speed differential, is at most 30% of the spindle rotational speed, that is, at most 30% of the above mentioned “absolute” rotational speed differential between the spindle and a stationary or non-rotating element. The bore tool drive is achieved essentially according the principle of the lead screw, which has been known for decades.

When the two elements of the auxiliary drive are driven rotationally, the so-called relative rotational speed, with which the two elements slide off against each other, is at most 30% of the absolute rotational speed, namely, the spindle rotational speed. This results in a significantly lower mechanical load on the auxiliary drive and, consequently, a significantly longer service life of the bore machine. Advantageously, the relative rotational speed may be as low as or lower than 15% of the spindle rotational speed, for example, may be between 2% and 15%, as a way to significantly reduce the mechanical load.

When describing the bore machine according to the invention, reference is made to a relative rotational speed, that is, a rotational speed differential between the two elements that are necessary to generate an oscillating motion that is significantly lower than the rotational speed of the spindle. A result of this reduced so-called rotational speed is that the spindle executes fewer than 10 lifts in the oscillating or bore operation during a single rotation. It is particularly advantageous that the spindle executes fewer than two lifts. The mechanical load of the bore unit, particularly of the auxiliary drive, is in this manner so small, that the service life of the machine is extended significantly yet, at the same time, the chip breakage necessary to achieve the desired precision is maintained. The number of the wave peaks and valleys determines the number of oscillating lifts that are executed by one relative rotation when the two elements of the auxiliary drive slide against each other around a complete rotation of 360 degrees and this also has an influence on the chip breakage.

The low relative rotational speed results in a smooth running spindle and tool, and that has a positive effect on the machining process. The longer service life of the bore machine also ensures that the functioning of the bore machine stays the same across the greatest possible number of bores and is not subjected to changes caused by wear. As a result, the greatest possible number of bores can be produced under uniform conditions, which represents an advantageous method of producing a particular bore.

Advantageously, the oscillating motion is not produced by just a single wave-shaped surface in the auxiliary drive that runs along an opposite surface, such as, for example, a pin or another jutting surface elsewhere. Rather, preferably two elements that cooperate with each other are provided in the auxiliary drive, each with a wave-shaped surface. The two elements with wave-shaped surface slide against each other and, as a result, the peaks of the one element dip into the valleys of the other, so that the relative motion between these two elements generates the oscillating motion. The two wave-shaped surfaces provide a greater contact surface, so that pressure applied across the area of the two elements is lower and, thus, the wear on the elements that slide against each other.

It is known to use special bore and countersink tools, which hereinafter, for reasons of simplicity, are designated simply as bore tools. These bore tools have a forward bore section as well as a following countersink section and make it possible to generate a bore with a countersink in the workpiece in a single machining step. With conventional bore machines, the forward travel of the spindle, and, thus, also of the bore machine, is halted at the countersink point, so that the spindle, in addition to the rotation, has only a very slight oscillating motion caused by the auxiliary drive.

By contrast, with the bore machine according to the invention, the operation of the auxiliary drive is halted before the countersink step is completed, so that the oscillating motion of the spindle no longer takes place, when the countersink operation is ended. This interruption of the oscillating motion provides a particularly smooth surface of the countersink. This smooth surface is free from so-called chatter marks, which normally can't be avoided if the spindle is oscillating while the countersinking section of the above mentioned bore and countersink tool creates the countersink in the workpiece. These so-called chatter marks can cause problems when the machined workpiece is assembled. For example, a fastener inserted into a bore, such as, for example, a rivet or a screw, may not make complete contact with the fastening surface, because the surface of the countersink has a certain waviness caused by chatter marks. The particular fastener is assembled with a specified tension, whereby the rivet or the screw is tightened to a specified torque. It can't be excluded that the wavy surface in the countersink won't deform slightly, which would allow the fastener to loosen over time, thereby endangering the safety of the produced connection of elements. If, however, operation of the auxiliary drive is halted, as described above, the oscillating motion of the spindle superposed over the actual forward travel movement does not occur. Countersink surfaces are thus produced with greater precision then previously possible, because, during the countersink process, this method first ensures that a smooth surface of the countersink is produced and second enables particularly precise determination of the depth of the countersink.

It is an advantage that, when two elements of the auxiliary drive are provided, each with a wave-shaped surface as described above, the relative movement of the two elements of the auxiliary drive can be halted after the bore is produced such that the wave peaks of the one element dip into the wave valleys of the other element. This provides the greatest possible surface contact between the two elements and very stable positioning of the two elements relative one another, which supports a reliable, play-free and secure guiding of the spindle and reliably avoids any relative movement of the two elements.

The spindle continues to rotate after the relative movement between the first and second elements has been stopped, in order to finish the countersinking process. In the interest of keeping cycle times to the shortest possible time, the relative movement of the two so-called elements is not interrupted at the begin of the machining step for the countersink. This is because, it is not a problem that the spindle is still oscillating at the beginning of the countersink step, even if chatter marks are initially created, because these chatter marks will be machined away automatically as the countersinking process progresses. Interrupting the oscillating motion of the spindle during the countersinking step and before the step is completed, is sufficient to ensure that the countersink is completed with the described advantages, namely, on the one hand, a very precisely determined position of the countersinking tool and, consequently, a very precisely specifiable depth of the countersink, and, on the other hand, a particularly smooth surface of the countersink that is reliably fee of chatter marks.

It is an advantage, that the bore machine may be driven solely with pneumatic power. Being able to forego electrical components, including an electric motor, makes it possible to produce a smaller bore machine with reduced weight. This bore machine also readily satisfies the requirements for higher protection classes, including those relating to explosion protection.

### BRIEF DESCRIPTION OF THE DRAWINGS

The present invention is described with reference to the accompanying drawings. In the drawings, like reference numbers indicate identical or functionally similar elements. The drawings are purely schematic in illustration.

FIG. 1 is a cross-sectional view of the bore machine according to the invention.

FIG. 2 is a radial view of two components of the auxiliary drive of the bore machine of FIG. 1.

FIG. 3 is a perspective view of the two components of FIG. 2.

FIG. 4 is a perspective view of two drive wheels of the bore machine of FIG. 1.

FIG. 5 illustrates a borer partially bored into a workpiece.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

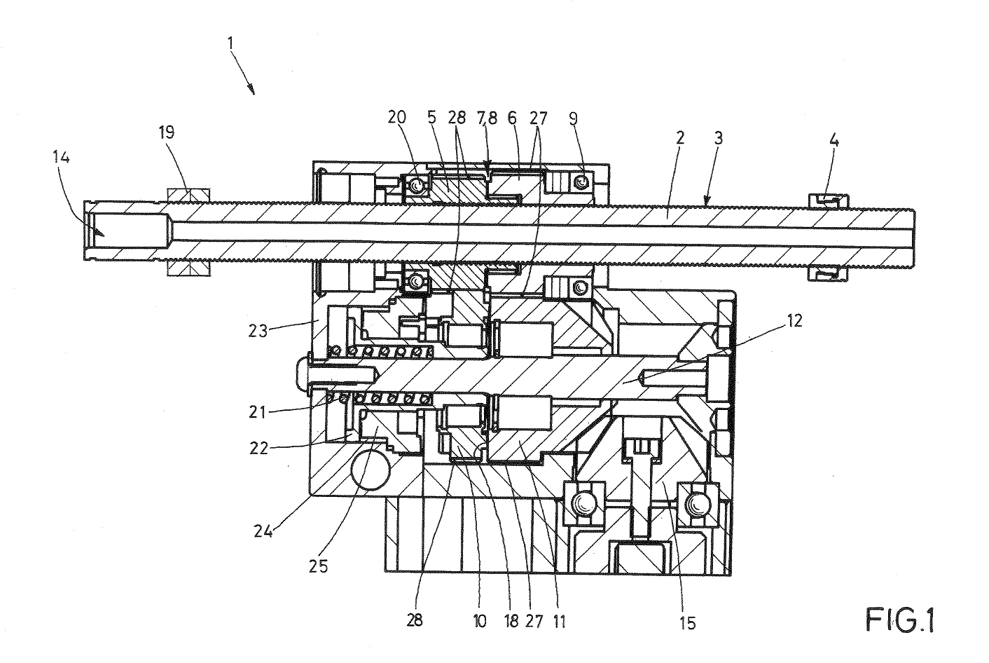

FIG. 1 is a cross-sectional view of a bore machine 1 according to the invention. The bore machine 1 has a housing 23 and a spindle 2. A thread 3 is provided on the outer surface of the spindle 2. A tool holder 14 in the form of a recess in the spindle 2 is provided at the left end of the spindle. A bore tool and, particularly, a combination bore and countersink tool, is insertable into the tool holder 14.

The operation of the bore machine 1 is described below. The description is based on the chronological progression of a bore and countersink machining step in a single operating cycle.

A single drive motor is required to drive the spindle 2. The drive motor drives an input wheel 15 that is constructed as a conical gear. The input wheel 15 forces a first drive wheel 11 that is assembled on a shaft 12 to rotate and the drive wheel 11, in turn, exerts a force on two additional wheels.

The drive wheel 11 drives a spindle gear 6 by means of a spur gear 27. The spindle gear 6 has a mating spur gearing 27 and causes the rotational movement of the spindle 2. A groove is provided around the outer circumference of the spindle 2, that runs in the longitudinal direction of the spindle 2 and engages with a dog 16 of the spindle gear 6, as shown in FIG. 3. When the spindle gear 6 remains at its position within the bore machine 1, but is rotating, the spindle 2 is forced to rotate with the same rotational speed, so that the spindle rotational speed corresponds to the rotational speed of the spindle gear 6.

FIG. 4 illustrates a cam gearing, that is provided at the axial end of the first drive wheel 11 and includes four cams 17. The first drive wheel 11 drives a second drive wheel 10 by means of this cam gearing. The second drive wheel 10 is also mounted on the shaft 12 and has four mating cams 18, which mesh between the four cams 17 of the first drive wheel 11. A biasing spring 21 presses the second drive wheel 10 against the first drive wheel 11, thereby transmitting power from the first drive wheel 11 to the second drive wheel 10 and meshing the cams 17 and 18 with each other.

The second drive wheel 10 drives a forward travel gear 5 by means of a circumferential spur gear 28, which runs on the spindle 2 and meshes with the thread 3 of the spindle 2, so that the rotational motion of the forward travel gear 5 forces an axial forward travel of the spindle 2 that corresponds to the thread pitch of the thread 3.

A first nut 4, shown at the right end of the spindle 2 travels on the thread 3 and serves as a first end stop, as a means of setting the depth of the bore. The first nut 4 determines the extent to which the spindle 2 may move in the axial direction during forward travel. The nut 4 may be adjusted for this purpose from the outside, whereby the necessary construction of the bore machine 1 to allow this is not shown in the simplified schematic figures, but is well known in the field. A second nut 19, shown at the left end of the spindle 2, serves as a second end stop of the spindle 2, which limits the return travel motion, as is discussed below.

An auxiliary drive 30 is provided to generate an oscillating movement of the spindle 2. This drive 30 comprises two elements that are essential for the oscillating motion: the forward travel wheel 5 and the spindle gear 6. The forward travel gear 5 is, at the same time, a part of the main drive of the spindle 2 and generates the forward travel of the spindle 2. The spindle gear 6 is also, at the same time, a part of the main drive and generates the rotational motion of the spindle 2. The two gears, forward travel gear 5 and spindle gear 6, are driven at slightly different rotational speeds, whereby the forward travel gear 5 rotates at a slightly higher rotational speed than the spindle gear 6.

Both drive wheels 10 and 11 run on the same shaft 12 and, because their cams 17 and 18 mesh, they rotate at the same rotational speed. Different rotational speeds of the forward travel gear 5 and the spindle gear 6 result from the slightly different transmission ratios between the second drive wheel 10 and the forward travel gear 5 on the one hand and the first drive wheel 11 and the spindle gear 6 on the other.

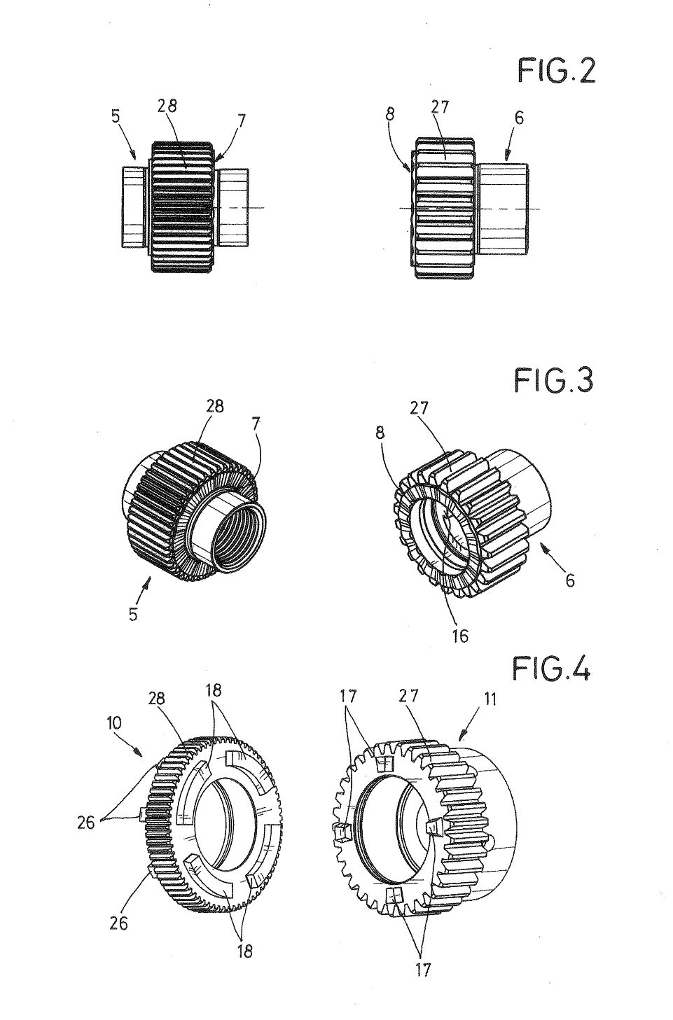

As shown in FIGS. 2 and 3, the forward travel gear 5 and the spindle gear 6 each have a waved surface 7 and 8, respectively, that extends annularly around the central axis of the respective gear and the spindle 2. The forward travel gear 5 and the spindle gear 6 fit against each other at these waved surfaces 7, 8. Due to the different rotational speeds of the two gears 5, 6, the waved surfaces 7 and 8 slide relatively slowly against each other, so that, for example, only approximately 1.5 lifts per rotation of the spindle 2 are made. This saves substantial wear on the bore machine 1 and, at the same time, ensures that the chips created in the machining process are reliably broken up, so they may be easily transported away from the site. The relative rotational speeds between the forward travel gear 5 and the spindle gear 6 are comparatively low, regardless of whether the two drive wheels 10 and 11 rotate with a low or high common rotational speed, such as, for example, at 300 rpm or 8000 rpm. The fact that the relative rotational speed lies significantly below the rotational speed of the spindle 2 conserves the auxiliary drive and, consequently, reduces wear on it.

The pressure that acts on the spindle 2 in the axial direction presses the two surfaces 7 and 8 against each other, when a workpiece is being machined. The forward travel gear 5, together with a ball bearing 20 that is assembled in the housing 23, is able to move away from the bore machine in the forward travel direction, when this pressure is not applied. In other words, the forward travel gear 5 is moves to the left as seen in FIG. 1, which shows a small room for play to the left of the ball bearing 20. The ability to set the auxiliary drive out of action when the spindle 2 is running without load further reduces the wear on the auxiliary drive, in addition to the already low wear operation of the auxiliary drive that results from the low relative rotational speed between the forward travel gear 5 and the spindle gear 6 and their wave-shaped surfaces 7 and 8.

The bore has reached the specified depth, when the nut 4 runs up against a bearing 9. The thread pitch of the thread 3 forces the forward travel gear 5 and the spindle gear 6 against each other and to act as a single block, because the spindle 2 cannot deviate to the left and be moved forward. The forward travel gear 5 and the spindle gear 6 no longer continue to run with a relative rotational speed together, but rotate at the same rotational speed. This means that the wave peaks of the one gear dip into the wave valleys of the other gear and begin to create a positive form-fit. This prevents oscillating motion of the spindle 2 from this point on in the cycle.

This synchronized running of the forward travel gear 5 and the spindle gear 6 in the end position of the spindle 2, as well as the different transmission ratios of the two drive wheels 10 and 11 drive the two drive wheels 10 and 11 beneath the forward travel gear 5 and the spindle gear 6 to now engage each other. Sloping flanks of the cams 17 and 18 between these two drives wheels 10 and 11 force the drive wheels 10 and 11 on the common shaft 12 apart from each other, whereby the second drive wheel 10 shown on the left in FIG. 1, which meshes with the forward travel gear 5, is pushed against the biasing spring 21 axially to the left. The gear teeth of the second drive wheel 10 contact only a partial surface of the gear teeth of the forward travel gear 5 and, as a result, the second drive wheel 10 is movable along the forward travel gear 5 in the longitudinal direction of the spindle 2.

The drives of the forward travel gear 5 and the spindle gear 6 are also disengaged. The first drive wheel 11 continues to run and drive the spindle 2 by means of the spindle gear 6, albeit without any oscillating motion, because the auxiliary drive is now off, and the forward travel gear 5 and the spindle gear 6 rotate without a relative rotational speed between each other, so that their wave-shaped surfaces 7 and 8 do not slide against each other.

The surface of the countersink is machined oscillation-free, with high quality and with the least possible surface roughness, thereby avoiding chatter marks and achieving optimal machining of the countersink surface.

A piston 22 is coupled with the second drive wheel 10, so that the drive wheel and piston together are moved to the left when the two drive wheels 10 and 11 are separated at the end of the spindle forward travel, as described above. When the piston has reached its end position near the housing 23, and is moved as far as possible to the left, together with the drive wheel 10, the piston 22 actuates a pneumatic valve by means of a so-called switching flag.

The pneumatic valve generates a pressure in a chamber 24 that is bounded by the piston 22, the housing 23, and a fixedly mounted limit bushing 25. This pressure supports the piston 22 in maintaining its end position near the end of the housing 23 against the force of the biasing spring 21, holding the second drive wheel 10 separated from the first drive wheel 11, and also keeping the gear teeth of the cams 17 and 18 apart.

The second drive wheel 10 contacts the limit bushing 25 in this position. Limit dogs 26 are provided on the limit bushing 25 and also on the drive wheel 10. These dogs 26 may be constructed, for example, similarly to the gear teeth on the cams 17 and 18. Several limit dogs 26 are shown in FIG. 4 on the drive wheel 10. The limit dogs 26 provide a torque-proof contact of the second drive wheel 10 against the limit bushing 25. This second drive wheel 10 is also rotationally fixed, i.e., does not rotate. Accordingly, the forward travel gear 5 is also unable to rotate, because it is engaged with the second drive wheel 10 via the spur gear 28.

The first drive wheel 11 continues to rotate and as a result continues to drive the spindle gear 6, while the forward travel gear 5 is prevented from rotating. The forward travel of the spindle 2 is finished and now the tool exerts no axial pressure on the spindle 2, and the pressure to hold the wave-shaped surfaces 7 and 8 pressed up against each other drops away. Because of the rotational drive of the spindle gear 6, the slanted profiles of the waves on the surfaces 7 and 8 move the forward travel gear 5 within the available play to the left against the ball bearing 20 and move the surfaces 7 and 8 away from each other. The spindle gear 6 is then able to continue to rotate freely, while the forward travel gear 5 remains rotationally fixed, i.e., unable to rotate.

The right drive wheel 11 continues to rotate together with the spindle gear 6. The spindle gear 6 and its dog 16 keep the spindle 2 in rotational motion. The spindle 2 rotates within the now fixed, i.e., non-rotating, forward travel gear 5, so that the axial direction of motion of the spindle 2 is reversed and the spindle 2 begins its return travel.

The return travel of the spindle 2 is limited by a second nut 19, shown on the left in FIG. 1, which serves as the second end stop for the spindle 2. When this nut 19 hits the housing 23 or moves slightly into the housing 23, it actuates a switching flag that is positioned there, which then actuates a pneumatic valve that switches off the motor mentioned at the beginning that drives the input wheel 15. Also, the pressure in chamber 24 is dissipated by means of a corresponding pneumatic valve, so that the biasing spring 21 now moves the piston 22 back to the right. The piston 22 takes along the second drive wheel 10, so that the cams 17 and 18 on the right of the drive wheel 11 mesh again. The bore machine 1 is now ready to begin a new cycle, and the cycle just described is repeated again.

The embodiment of the bore machine described and shown is constructed as a pneumatic bore machine. A person of skill in the art will recognize that details of the construction of this embodiment may be de-coupled from the overall context of this embodiment, or may be modified, or applied to another similarly constructed bore machine, for example to an electrically operated bore machine.

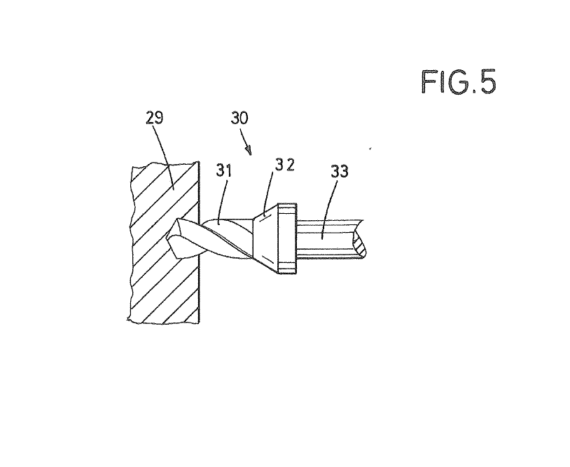

A machining method according to the invention ensures the production of a very precise bore in a workpiece 29, such as is shown in FIG. 5. The bore machine used has a spindle that carries the bore tool and may be constructed as the bore machine 1 according to the invention. In any case, a main drive is used to drive the spindle of the particular bore machine used rotationally as well as in a forward travel. A so-called auxiliary drive generates an oscillating motion in the axial direction of the spindle and is superposed over the forward travel motion.

The auxiliary drive has a first element with a wave-shaped surface, which is movable relative a second element of the auxiliary drive, so that a relative motion of these first and second elements to each other, so that one element is driven to follow the wave peaks and valleys of the other, creating the oscillating motion, which is then transmitting to the spindle. The method according to the invention further suggests that the two elements of the auxiliary drive be driven such, that the relative motion of these two elements to each other is at most 30% of the relative motion between the spindle and one of these two elements.

A tool 30 that is a combination bore and countersink tool is used for the machining of a very precise bore in the workpiece 29 according to this method. The tool has a clamping section 33, by means of which it is clamped into a bore machine, for example, the bore machine 1. The tool 30 has a bore section 31, that is constructed as a conventional bore tool and which penetrates the workpiece 29, as shown in FIG. 5. The tool 30 also has a countersink 32, that is also constructed in conventional manner as a countersink tool.

With continued reference to FIG. 5, when the spindle of the bore machine is moved in forward travel and the tool 30 penetrates farther into the workpiece 29, a throughbore is formed in the workpiece. When the tool 30 is then moved forward even farther into the workpiece 29, the countersink section 32 is forced against the workpiece 29 and penetrates the workpiece, so that, upon completion of the bore, the bore is deburred and the countersink formed, with the same tool. After machine the bore with the bore section 31, and before the countersink is completed, the two elements of the auxiliary drive of the bore machine, which previously moved relative one another, are now fixed and the relative motion of the two elements stopped. The spindle of the bore machine, however, continues to move rotationally, yet without any oscillating motion on the spindle. As a result, the tool 30 is moved without the oscillating motion, so that the countersink that is formed by the countersink section 32 has a smooth surface.

The length of the bore section 31 and the thickness of the workpiece 29 as shown in the figure are purely for purposes of illustration. It is understood that a closed-end or blind bore, rather than a throughbore, may be machined into a thicker workpiece. And, of course, the bore section of the tool, when adapted to the thickness of the workpiece, should be selected to be as short as possible, so that the entire bore process is completed in the shortest time possible.

It is understood that the embodiments described herein are merely illustrative of the present invention. Variations in the construction of the bore machine may be contemplated by one skilled in the art without limiting the intended scope of the invention herein disclosed and as defined by the following claims.

What is claimed is:

1. A bore machine for machining a very precise bore, the bore machine comprising:
a spindle for holding a bore tool, the spindle having a longitudinal axis;
a main drive that drives the spindle to rotate and to move in an axial direction in forward travel and in return travel;
an auxiliary drive that generates an oscillating motion in the axial direction and that is overlayed over the forward travel of the spindle, the auxiliary drive including a first element and a second element, the first element having a wave-shaped surface and being movable relative the second element;
wherein, during motion between the first element and second element relative to each other, the second element is driven to follow wave peaks and wave valleys of the first element to generate the oscillating motion; and
wherein the first element and second element are driven such, that motion relative to each other is at most 30% of the rotational speed of the spindle.
